(19) United States
(12) Patent Application Publication
(10) Pub. No.: US 2005/0174530 A1
(43) Pub. Date: Aug. 11, 2005

(54) Socket connector

(76) Inventor: Nonu Ifergan, Mont-Royal (CA)

Correspondence Address: Blake, Cassels & Graydon LLP;Commerce Court West, 199 Bay Street, Box 25, Toronto, ON, M5L 1A9, CA

(21) Appl. No.: 11/034,954

(22) Filed: Jan. 14, 2005

Related U.S. Application Data
(60) Provisional application No. 60/536,717, filed on Jan. 16, 2004.

(51) Int. Cl. G02C 7/08

(52) U.S. Cl. 351/57

(57) ABSTRACT

An eyeglass device is provided having a main frame and an auxiliary frame which can be mounted upon the main frame. One of the main frame or the auxiliary frame has at least one socket which is sized to receive at least one tongue which protrudes from the other of the main frame or the auxiliary frame. At least one of the tongue and socket has a magnet associated therewith. The auxiliary frame is attached to the main frame by inserting the at least one tongue into corresponding ones of the at least one socket and secured by magnetic attraction therebetween.

This application claims priority from U.S. Provisional Patent Application No. 60/536,717 filed on Jan. 16, 2004.

### FIELD OF THE INVENTION

The present invention relates to eyeglasses.

### DESCRIPTION OF THE PRIOR ART

The use of eyeglasses to correct vision is well known as is the use of auxiliary lenses to add protection against the environment. The auxiliary lenses are typically tinted to protect against excessive sunlight. Use of an auxiliary lens avoids the need to physically change eyeglasses and avoids the expense and inconvenience of a second pair of eyeglasses.

The auxiliary lenses have previously been secured mechanically to the primary lens through a series a clips but these are relatively difficult to attach. More recently, the auxiliary lenses have been secured through the interaction of magnets that have rendered the installation much simpler and more convenient. Previous proposals are known in which the magnets are embedded within the bridge. With such an arrangement, the manufacture of the eyeglasses is complicated and the magnets are visible in use.

An alternative arrangement is that shown in U.S. Pat. No. 5,568,207 to Chao in which the magnets are located in the temporal regions with arms extending rearwardly to the magnets. This arrangement enhances the aesthetic appeal by effectively hiding the magnets but relies on the magnetic attraction to locate the arms on the magnets.

It is therefore an object of the present invention to provide eyeglasses in which the above disadvantages are obviated or mitigated.

### SUMMARY OF THE INVENTION

In one aspect, the present invention provides an eyeglass device comprising a main frame, an auxiliary frame, at least one socket formed on one of the main frame or the auxiliary frame and sized to receive at least one tongue protruding from the other of the main frame or the auxiliary frame, at least one of the at least one tongue and at least one socket having a magnet associated therewith, wherein the auxiliary frame is attached to the main frame by inserting the at least one tongue into corresponding ones of the at least one socket and secured by magnetic attraction therebetween.

### BRIEF DESCRIPTION OF THE DRAWINGS

Embodiments of the invention will now be described by way of example only with reference to the accompanying drawings in which:

FIG. 1 is a general perspective view of eyeglasses.

FIG. 2 is a detailed view on an enlarged scale of a portion of the eyeglasses shown in FIG. 1.

FIG. 3 is a view on the line III-III of FIG. 2.

FIG. 4 is a view similar to FIG. 2 of an alternative embodiment of eyeglasses.

FIG. 5 is a view similar to FIG. 2 of a further embodiment of eyeglasses.

FIG. 6 is a general perspective view of a further alternative embodiment of eyeglasses.

FIG. 7 is a side view of the eyeglass shown in FIG. 6.

FIG. 8 is a perspective view of a temple portion of a further embodiment of eyeglasses.

FIG. 9 is a view on an enlarged scale of the temple of FIG. 8.

### DESCRIPTION OF THE PREFERRED EMBODIMENTS

Referring therefore to FIG. 1, eyeglasses generally indicated at 10 include a primary frame 12 and an auxiliary frame 14. The primary frame 12 has a pair of lens openings 16 that are interconnected by a bridge 18. Temples 20 are pivotally connected to the lens openings 16 for securing the primary frame 12 to the user.

The auxiliary frame 14 similarly has a pair of lens openings 22 interconnected by a bridge 24.

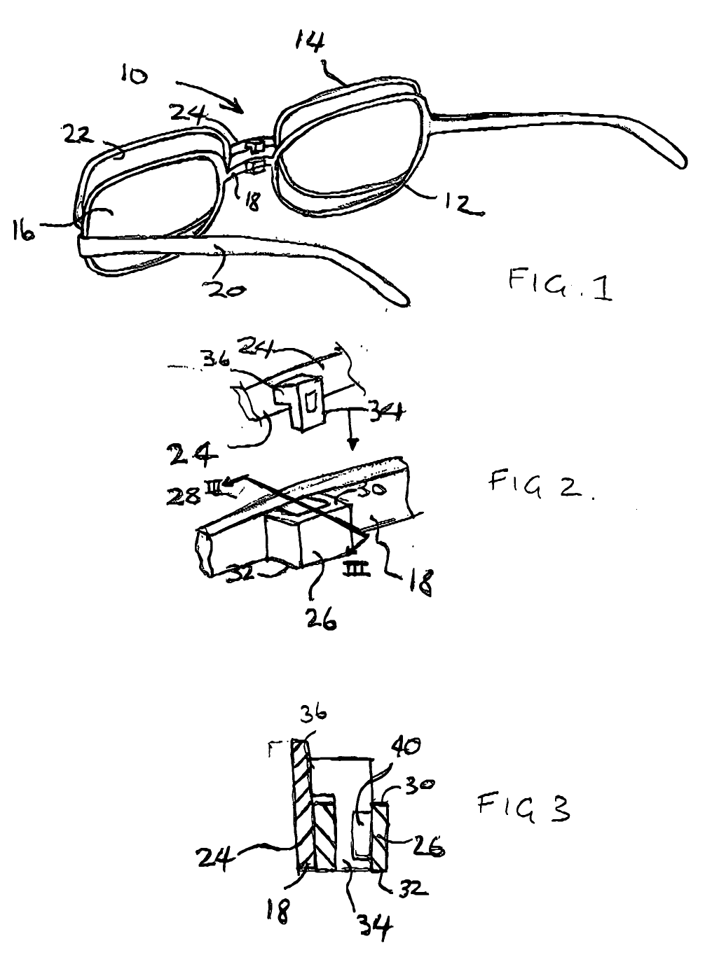

As can be seen in greater detail in FIG. 2, a socket 26 is secured to the bridge 18 on a rearwardly directed surface. The socket 26 has a central aperture 28 that extends from the upper surface 30 to the lower surface 32. The aperture 28 is rectangular in cross-section and sized to receive a downwardly projecting tongue 34 secured to the bridge 24. The tongue 34 is supported on the rear surface of the bridge 34 by a spacer block 36 to provide sufficient clearance for the tongue 34 to be aligned with the aperture 28. A magnetic member 40 is embedded in the tongue 34 at a position that would locate it within the socket 32.

As shown in FIG. 3, the tongue 34 is received within the aperture 28 so as to provide a snug fit with the magnetic member 40 in engagement with the wall of the socket 26 through magnetic attraction. The socket 26 is formed from a magnetic material and therefore the magnetic member 40 is retained within the socket 26. The auxiliary lenses are thus readily mounted and positively retained by the socket 26 and removal of the lenses 14 is accomplished by a simple upward movement. The tongue 34 and socket 32 are rectangular in cross section and therefore inhibit relative movement between the frames. This ensures the frames are held in proper spaced relationship to one another.

The magnetic member 40 is preferably a magnet with the socket 26 formed from a magnetizable material 80 that there is a force of attraction between the tongue 34 and socket 36. Alternatively, the tongue 34 may be made of magnetizable material and a magnet embedded within the socket. For maximum retention, a magnet will be embedded in both the tongue 34 and socket 36 so as to be juxtaposed when the tongue 34 is inserted. In each case the tongue 34 and socket 36 are retained by the magnetic force acting between them.

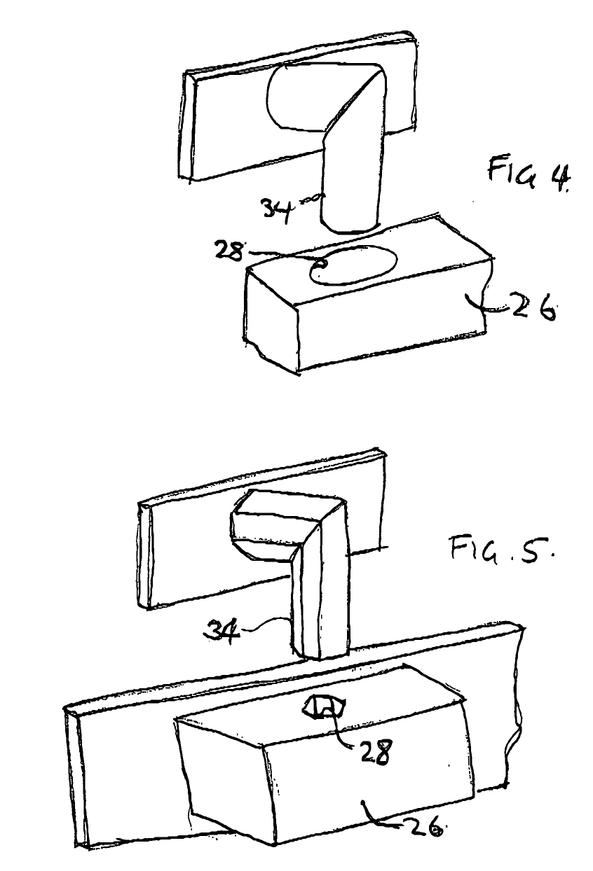

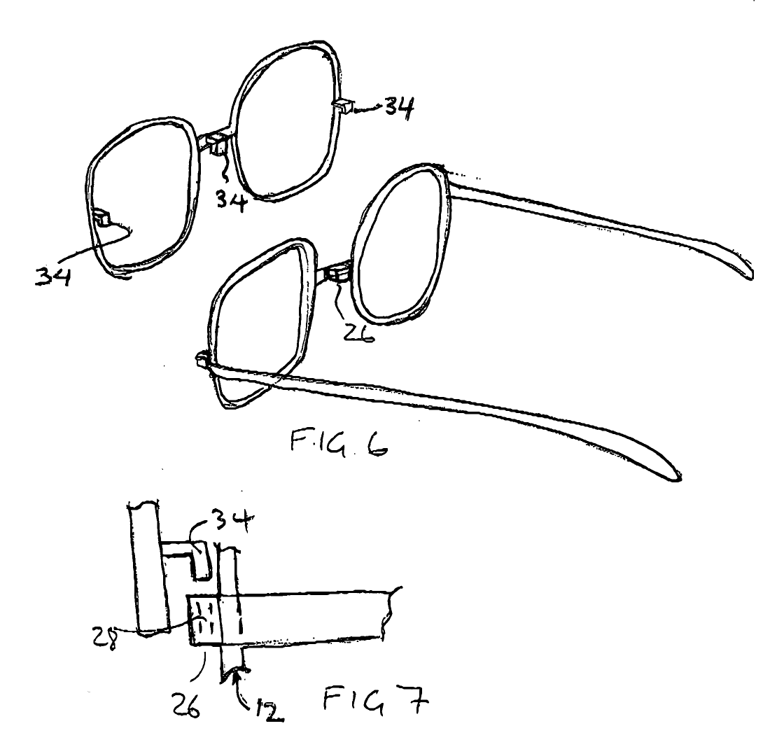

In the embodiment of FIGS. 1 to 3, the tongue 34 is rectangular. Alternative configurations of the tongue 34 may be utilized as shown in FIGS. 4 and 5. In the embodiment of FIG. 4, the tongue 34 is circular in cross-section as is the aperture 28 in the socket 26. The tongue 34 is made from a bar magnet and therefore is attracted to the socket 26 when inserted.

In the embodiment of FIG. 5, the tongue 34 is formed from a hexagonal magnetic member with the socket 28 similarly being of hexagonal cross-section. The tongue 34 may thus be inserted in the aperture 28 in the socket 26 and retained through the action of the magnetic forces.

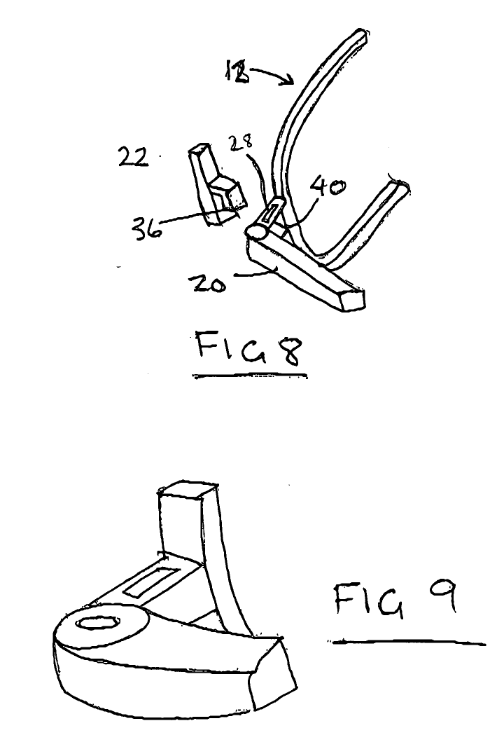

In the arrangements described above, the auxiliary lens is secured solely at the bridge 18. In a further embodiment shown in FIGS. 6 and 7, sockets 26 are located at the bridges 18 and also on the forwardly directed surface of the mainframe 12 adjacent the temples. As can be seen in FIG. 7, the socket 26 projects forwardly from the mainframe 12 with an aperture 28 extending through the socket. The auxiliary lens 14 is formed with a tongue 34 at the bridge and at each of the temple regions which are engaged in respective sockets. The tongue carries a magnetic member for securing to the sockets 26 that are made of a magnetic material.

It will be appreciated that the sockets 26 located at the temples may be used independently of the socket at the bridge.

A further arrangement of temple mounting is shown in the embodiments of FIGS. 8 and 9. As seen in FIG. 8, the temples 20 are connected to the lens openings 16 by an extension arm 40. The extension arm 40 has an aperture 28 that is dimensioned to receive the tongue 36 secured to the auxiliary lens 22. The tongue 36 may thus be inserted into the aperture 28 and retained by a magnetic member carried on the tongue 36. It will be appreciated that the socket 26 may be secured behind the arm 40 if preferred to maintain the integrity of the arm.

It will be appreciated that the socket 26 may also be formed on the auxiliary frame 14 whilst the tongue 34 is supported on the main frame 14, as desired. Accordingly, the socket 26 and tongue 34 may be supported on either a rearwardly directed surface of the frame by which it is supported or on a forwardly directed surface as desired. Likewise, the socket 26 may also be supported on either rearwardly or forwardly directed surfaces of the frame in which it is formed.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. An eyeglass device comprising a main frame, an auxiliary frame, at least one socket formed on one of said main frame or said auxiliary frame and sized to receive at least one tongue protruding from the other of said main frame or said auxiliary frame, at least one of said tongue and socket having a magnet associated therewith, wherein said auxiliary frame is attached to said main frame by inserting said at least one tongue into corresponding ones of said at least one socket and secured by magnetic attraction therebetween.

2. An eyeglass device according to claim 1 wherein said at least one tongue protrudes downwardly and said at least one socket extends outwardly from said main frame and has a downwardly extending aperture therethrough.

3. An eyeglass device according to claim 2 wherein said at least one tongue is supported by a spacer block to provide clearance for said tongue to align with said aperture.

4. An eyeglass device according to claim 1 wherein a pair of apertures are formed in respective temple regions of said main frame, each of said apertures providing one of said at least one socket.

5. An eyeglass device according to claim 1 wherein said at least one tongue is supported on a rearwardly directed surface of said auxiliary frame.

6. An eyeglass device according to claim 1 wherein said at least one tongue is supported on a rearwardly directed surface of said main frame.

7. An eyeglass device according to claim 1 wherein said at least one tongue has a magnet associated therewith.

8. An eyeglass device according to claim 7 wherein said magnet of each of said at least one tongue is embedded therein.

9. An eyeglass device according to claim 1 wherein said at least one socket extends outwardly on a forwardly directed surface of said main frame.

10. An eyeglass device according to claim 1 wherein said at least one socket extends outwardly on a rearwardly directed surface of said main frame.

11. An eyeglass device according to claim 1 wherein said at least one socket extends outwardly on a rearwardly directed surface of said auxiliary frame.

12. An eyeglass device according to claim 1 wherein said at least one socket is made of a magnetic material.

13. An eyeglass device according to claim 1 wherein said at least one socket has a magnetic member having an internally exposed face for magnetic attraction with said at least one tongue.

14. An eyeglass device according to claim 1 wherein said at least one tongue and an aperture in each of said at least one socket are rectangularly shaped.

15. An eyeglass device according to claim 1 wherein said at least one tongue and an aperture in each of said at least one socket are cylindrically shaped.

16. An eyeglass device according to claim 1 wherein said at least one tongue and an aperture in each of said at least one socket are hexagonally shaped.

17. An eyeglass device according to claim 1 having a single socket and a single corresponding tongue.

18. An eyeglass device according to claim 17 wherein said socket is supported on a bridge portion of one of said main frame or said auxiliary frame and said tongue is supported on a bridge portion of the other of said main frame or said auxiliary frame.

19. An eyeglass device according to claim 1 having three sockets and three corresponding tongues.

20. An eyeglass device according to claim 19 having a pair of said sockets supported on respective temple portions of one of said main frame or said auxiliary frame and a pair of said tongues supported on respective corresponding temple portions of the other of said main frame or said auxiliary frame, and the remaining ones of said sockets and said tongues supported on respective bridge portions of said main frame or said auxiliary frame.
